(19) United States
(12) Patent Application Publication
(10) Pub. No.: US 2005/0119377 A1
(43) Pub. Date: Jun. 2, 2005

(54) Colored resin composition for laser welding and composite molding product using the same

(76) Inventors: Tomo Ishii, Nagoya (JP); Shunji Sato, Nagoya (JP); Masahiro Nishizawa, Nagoya (JP)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 11/001,402

(22) Filed: Dec. 1, 2004

(30) Foreign Application Priority Data
Dec. 2, 2003 (JP) 2003-403369

(51) Int. Cl. C08K 5/34; C08K 3/38; C08K 3/10; C08K 3/34; C08K 3/04; C08K 3/40

(52) U.S. Cl. 524/88; 524/404; 524/495; 524/494; 524/445

(57) ABSTRACT

A colored resin composition for laser welding which comprises: (A) a polybutylene terephthalate based resin comprising polybutylene terephthalate or polybutylene terephthalate and a polybutylene terephthalate copolymer, (B) at least one kind of resin selected from polycarbonate resins, styrene based resins and polyethylene terephthalate resins, and (C) two or more kinds of organic pigments, wherein the resin (B) accounts for 1 to 50% by weight of the total amount of the polybutylene terephthalate based resin (A) and the resin (B), the pigment (C) is included in an amount of 0.02 to 0.5 parts by weight per 100 parts by weight of the total amount of the polybutylene terephthalate based resin (A) and the resin (B), laser beam transmittance in the near infrared radiation region of the wavelength of 800 nm to 1100 nm is 10% or greater when it is measured with a sample thickness of 3 mm, and L value which indicates the luminosity is less than 50.

### BACKGROUND OF THE INVENTION

The present invention relates to a resin composition for laser welding which is well-balanced and excellent in heat resistance, thermal shock property, appearance of molding article surface, dimensional stability and laser welding property, and a composite molding product using the same, and more particularly, relates to a polybutylene terephthalate based resin composition which is suitable for a composite molding product and the like obtained by laser welding to another article, and a composite molding product using the same.

Polybutylene terephthalate resins have been extensively utilized as an injection molding product, in fields such as machine parts, electrical/communication parts, automobile parts and the like by employing their excellent injection moldability, mechanical characteristics, heat resistance, electrical characteristics, chemical resistance and the like. However, although efficiency of formation of the injection molding articles is favorable, there exist limitations in shape in terms of flow characteristics and structure of the mold. Thus, molding involves difficulties when a too complicated article is to be produced.

Therefore, upon junction of each part accompanied by a complicated shape of the product, junction by means of an adhesive, mechanical junction by means of a bolt or the like, has been conventionally carried out. However, junction with an adhesive has involved problems of adhesion strength, and mechanical junction with a bolt or the like has involved problems of cost, efforts required for binding and increase in weight. On the other hand, in respect of weldings with external heating such as laser weldings, hot plate weldings and the like as well as weldings with frictional heating such as vibration weldings, ultrasonic weldings and the like, junction in a short period of time is enabled, and in addition, because neither adhesive nor metal parts are used, problems resulting from cost, increase in weight, environmental contamination and the like are not caused. Therefore, assembly using any such processes has been increased.

Laser welding which is one of the weldings with external heat is a construction method in which a laser beam is irradiated on overlaid resin molding products to allow transmission into the irradiated one while allowing absorption into another one, thereby executing melting and fusion. Thus, it is a construction method which has spread across a wide spectrum of fields by employing advantages such as possible three dimensional junction, processing without contact, and absence of generation of weld flash.

Polybutylene terephthalate based resins frequently applied in various kinds of usages have an extremely low laser beam transmittance in comparison with those of thermoplastic resins such as nylon resins. Thus, when the laser welding construction method is applied using a polybutylene terephthalate based resin as a molding article on the side of laser beam transmission, limitation in thickness is extremely restricted due to the low laser beam transmittance thereof. Therefore, a measure is required by way of thin-walling in order to improve the laser beam transmittance, leading to inferior flexibility of the product design.

According to JP-A-2001-26656 (paragraphs [0007] to [0024]), difficulties in welding resulting from low laser transmittivity are avoided through controlling the melting point using a polybutylene terephthalate based copolymer in a laser welding construction method, thereby elevating the flexibility of the product design.

Furthermore, depending on the site to be used, not only a bright and clear color tone but also a dark color tone may be required for a polybutylene terephthalate based resin for use in a member on the side of laser transmission in respect to color tone balance with another part and of the design. In such cases, it is required to achieve the appearance of a color tone without impairing the laser transmittivity.

JP-A-2000-309694 (paragraphs [0005] to [0014]) discloses a technique for coloring without impairing the laser beam transmittivity using a sand plast based pigment as a laser beam nonabsorptive colorant. In the document, a compound pigment produced from a nonabsorptive pigment (a sand plast based pigment) is described to be effective. The sand plast based pigment referred to in the document is a dye derived from a quinophtharone based dye or an anthraquinone based dye, and involves a technique to obtain a black laser beam transmittable material by using the dye, not an organic pigment, which can be melted/dispersed in a resin (i.e., having a polymer solubility).

JP-A-2001-71384 (paragraphs [0008] to [0014]) describes use of an anthraquinone based, perylene based, perynone based, heterocycle based, disazo based or monoazo based organic dye as a colorant which does not exhibit absorptivity for a laser beam which enables coloring without impairing the laser beam transmittivity. Furthermore, for retaining the laser beam transmittivity and allowing the appearance of a dark color tone, not a pigment based colorant which exhibits laser beam absorptivity but a dye based colorant has been generally used.

JP-A-2003-136601 (paragraphs [0006] to [0022]) describes preferable examples of the dye to be added into a black coloring material for permitting transmission of a laser beam including monoazo metal dyes, anthraquinone dyes, perynone dyes and quinophtharone dyes.

### SUMMARY OF THE INVENTION

However, as is described in JP-A-2001-26656, great improvements in laser beam transmittivity are not expected by merely controlling the melting point, therefore, improvement in flexibility upon design of a molding product in connection with the wall thickness cannot be expected. Also, there have existed problems involving impairment of moldability of the polybutylene terephthalate based resin. Furthermore, it has been proven that the colorant to be compounded may decrease the laser beam transmittivity, and there have existed technical problems of impossible appearance of a dark color tone, and the like because a colorant must be selectively compounded to achieve favorable laser beam transmittivity. Moreover, dyes described in JP-A-2000-309694, JP-A-2001-71384, JP-A-2003-136601 have a sublimation and a melting point, therefore, there exist problems involved in staining of the mold upon injection molding, and in thermal stability during retention.

An object of the present invention is to resolve the conventional problems as described above, and to provide a colored resin composition for laser welding which can be applied as a molding product on the side of the laser beam transmission without impairing flexibility of the product design, having a dark color tone, and giving less stain on the mold upon injection molding.

In order to solve the problems as described above, aspects of the present invention are as follows.

(1) A colored resin composition for laser welding which comprises:
(A) a polybutylene terephthalate based resin comprising polybutylene terephthalate or polybutylene terephthalate and a polybutylene terephthalate copolymer,
(B) at least one kind of resin selected from polycarbonate resins, styrene based resins and polyethylene terephthalate resins, and
(C) two or more kinds of organic pigments, wherein
the resin (B) accounts for 1 to 50% by weight of the total amount of the polybutylene terephthalate based resin (A) and the resin (B), and
the pigment (C) is included in an amount of 0.02 to 0.5 parts by weight per 100 parts by weight of the total amount of the polybutylene terephthalate based resin (A) and the resin (B);

(2) A colored resin composition for laser welding which comprises:
(A) a polybutylene terephthalate based resin comprising polybutylene terephthalate or polybutylene terephthalate and a polybutylene terephthalate copolymer,
(B) at least one kind of resin selected from polycarbonate resins, styrene based resins and polyethylene terephthalate resins, and
(C) two or more kinds of organic pigments, wherein
the resin (B) accounts for 1 to 50% by weight of the total amount of the polybutylene terephthalate based resin (A) and the resin (B),
the pigment (C) is included in an amount of 0.02 to 0.5 parts by weight per 100 parts by weight of the total amount of the polybutylene terephthalate based resin (A) and the resin (B),
laser beam transmittance in the near infrared radiation region of the wavelength of 800 nm to 1100 nm is 10% or greater when it is measured with a sample thickness of 3 mm, and
L value which indicates the luminosity is less than 50;

(3) The colored resin composition for laser welding according to the above item (1) or (2) which further comprises (D) of at least one kind of filler selected from inorganic fillers and organic fillers added and compounded in an amount of 1 to 200 parts by weight per 100 parts by weight of the total amount of the polybutylene terephthalate based resin (A) and the resin (B);

(4) The colored resin composition for laser welding according to any one of the above items (1) to (3) which further comprises (E) a styrene based elastomer added and compounded in an amount of 1 to 50 parts by weight per 100 parts by weight of the total amount of the polybutylene terephthalate based resin (A) and the resin (B);

(5) The colored resin composition for laser welding according to the above item (4) wherein the styrene based elastomer (E) has a light transmittance in the region of the wavelength of 400 nm to 1100 nm, which is higher than the light transmittance of polybutylene terephthalate in the same region of the wavelength; and

(6) A composite molding article obtained by laser welding of a molding article which comprises the colored resin composition for laser welding according to any one of the above items (1) to (3).

The colored resin composition for laser welding of the present invention is suitably used for a molding product on the side of the laser beam transmission because it does not impair flexibility of the product design, has a dark color tone, and gives less stain to the mold upon injection molding.

### BRIEF DESCRIPTION OF THE DRAWINGS

FIG. 1A is a plan view illustrating an insert molding article used in the evaluation of thermal shock resistance in the Example; and FIG. 1B is a side view illustrating the same molding article. Further, a part with a wavy line indicates an insert metal covered by a resin.

FIG. 2A is a plan view illustrating a test piece for evaluating laser beam transmittivity used in the Example; and FIG. 2B is a side view illustrating the same test piece.

FIG. 3A is a plan view illustrating a test piece for laser welding used in the Example; and FIG. 3B is a side view illustrating the same test piece.

FIG. 4 is a schematic view illustrating an outline of a laser welding process.

FIG. 5A is a plan view illustrating a test piece for measuring strength of the laser welding used in the Example; and FIG. 5B is a side view illustrating the same test piece.

### DESCRIPTION OF SYMBOLS

1. Insert molding article
2. Resin
3. Sprue
4. Insert metal
5. Resin unfilled part
6. Runner
7. Gate
8. Test piece for evaluating laser beam transmittivity
9. Test piece for laser welding (sample on the side of laser beam absorption)
10. Laser beam irradiated part
11. Laser beam
12. Track of laser beam
13. Sample on the side of laser beam transmission
14. Sample on the side of laser beam absorption
15. Test piece for measuring strength of laser welding
16. Laser welding part

### DESCRIPTION OF THE PREFERRED EMBODIMENTS

Hereinafter, modes for carrying out the present invention are explained.

The polybutylene terephthalate based resin (A) (hereinafter, may also be referred to as (A) ingredient) referred to according to the present invention may be either the above-mentioned polybutylene terephthalate alone, or any combination of polybutylene terephthalate with a polybutylene terephthalate copolymer.

The polybutylene terephthalate used in the present invention is a polymer obtained by a polycondensation reaction of terephthalic acid (or an ester formative derivative thereof such as dimethyl terephthalate) and 1,4-butanediol (or an ester formative derivative thereof).

Furthermore, examples of the polybutylene terephthalate copolymer which can be used in combination with the above-mentioned polybutylene terephthalate include copolymerized products of terephthalic acid (or an ester formative derivative thereof such as dimethyl terephthalate) and 1,4-butanediol (or an ester formative derivative thereof), and another dicarboxylic acid (or an ester formative derivative thereof) or another diol (or an ester formative derivative thereof) which can be copolymerized therewith. Among them, copolymers obtained by copolymerization with another dicarboxylic acid (or an ester formative derivative thereof) as a third component are preferred.

In consideration of the moldability, the ratio of copolymerization of other dicarboxylic acid (or an ester formative derivative thereof) is preferably in the range of 3 to 30 mol %, and more preferably in the range of 3 to 20 mol % of the entire dicarboxylic acid component.

Moreover, in consideration of the moldability, the ratio of copolymerization of other diol (or an ester formative derivative thereof) is preferably in the range of 3 to 30 mol %, and more preferably in the range of 3 to 20 mol % of the entire diol component.

Examples of the above-mentioned other dicarboxylic acid include aromatic dicarboxylic acids such as isophthalic acid, phthalic acid, 2,6-naphthalenedicarboxylic acid, 1,5-naphthalenedicarboxylic acid, bis(p-carboxyphenyl)methane, anthracenedicarboxylic acid, 4,4′-diphenyl ether dicarboxylic acid and 5-sodium sulfo isophthalate; aromatic dicarboxylic acids such as adipic acid, sebacic acid, azelaic acid and dodecanedionic acid; alicyclic dicarboxylic acids such as 1,3-cyclohexanedicarboxylic acid and 1,4-cyclohexanedicarboxylic acid, and the like.

When the polybutylene terephthalate copolymer is used alone as the ingredient (A), addition of at least one selected from polycarbonate resins, styrene based resins, and polyethylene terephthalate resins is not preferred because the moldability may be deteriorated.

Viscosity of the ingredient (A) is not particularly limited as long as melting and kneading can be executed, however, it is preferred that intrinsic viscosity as measured at 25° C. using an o-chlorophenol solution is 0.36 to 1.60.

According to the present invention, at least one kind of resin which is selected from polycarbonate resins, styrene based resins, and polyethylene terephthalate resins is used as an ingredient (B) together with the ingredient (A), however, use of a polycarbonate resin is preferred for obtaining a composition that is excellent in laser beam transmittivity. By using the resin as described above, the laser beam transmittance in the near infrared radiation region of the wavelength of 800 nm to 1200 nm can be 10% or greater when it is measured with a sample thickness of 3 mm, thereby enabling achievement of favorable laser transmittivity. In addition, use of polycarbonate among the above-mentioned resins can achieve a particularly high laser beam transmittance.

In light of the effect of improving laser beam transmittivity, amount of the ingredient (B) to be included in the total amount of the ingredient (A) and the ingredient (B) is 1 to 50% by weight, and preferably 5 to 40% by weight per 100 parts by weight of the total amount of the ingredient (A) and the ingredient (B). When the amount of the ingredient (B) to be included is less than 1% by weight, the laser beam transmittance may be less than 10%, which may lead to loss of welding strength, while when it is greater than 50% by weight, it is not preferred because moldability and rigidity at a high temperature may be deteriorated.

According to the present invention, use of two or more kinds of organic pigments (C) is required. By using two or more kinds of organic pigments (C), a dark color tone can be achieved, and in addition, a high laser beam transmittance can be achieved. It is preferred that the two or more kinds of organic pigments of the ingredient (C) for use in the present invention are organic pigments including two or more kinds of organic pigments which are of phthalocyanine based, azo based, perynone based, anthraquinone based or the like. Examples of the color tone include yellow, orange, red, purple, blue, green and the like. Coloring of a resin can be accomplished to give a desired color tone through compounding these ingredients in combination. In general, pigments are classified into organic pigments having an azo based, or polycylic based structure, and inorganic pigments comprising a metal oxide, a chromate salt, a sulfide, a silicate salt, a carbonate, ferrocyanide or the like. According to the present invention, the above-mentioned effect can be achieved by using an organic pigment among these pigments, as described above. Use of such organic pigments instead of the dye which has been conventionally used for coloring a resin can prevent the mold from staining with the dye evaporated by heating upon molding. The dye referred to herein is a dye stuff which is dissolved in a medium such as water, a solvent, a fat or oil, or the like, and includes no particle. Such a dye is excellent in color formation properties, however, to the contrary, it is inferior in heat resistance and weather resistance. In these respects, dyes and pigments are different from each other.

In general, pigment based colorants exhibit absorptivity for laser beams. Therefore, two kinds of organic pigments must be selectively used in the present invention, and the amount of their use must be controlled such that the laser beam transmittance in the region of the wavelength of 800 nm to 1200 nm becomes 10% or greater when it is measured with a sample thickness of 3 mm. According to the present invention, amount of the ingredient (C) to be included per 100 parts by weight of the total amount of the ingredient (A) and the ingredient (B) may be 0.02 to 0.5 parts by weight, and preferably 0.03 to 0.1 parts by weight for allowing appearance of a dark color tone, in particular. Accordingly, a favorable balance between the color tone of the molding article, and mechanical physical property and laser beam transmittivity can be achieved. When the amount of the ingredient (C) to be included is less than 0.02 parts by weight, failure in appearance of a color tone of the molding article is caused leading to defects such as color heterogeneity and the like. On the other hand, use in an amount of greater than 0.5 parts by weight is not preferred because of deterioration of mechanical physical properties and the laser beam transmittance being less than 10%.

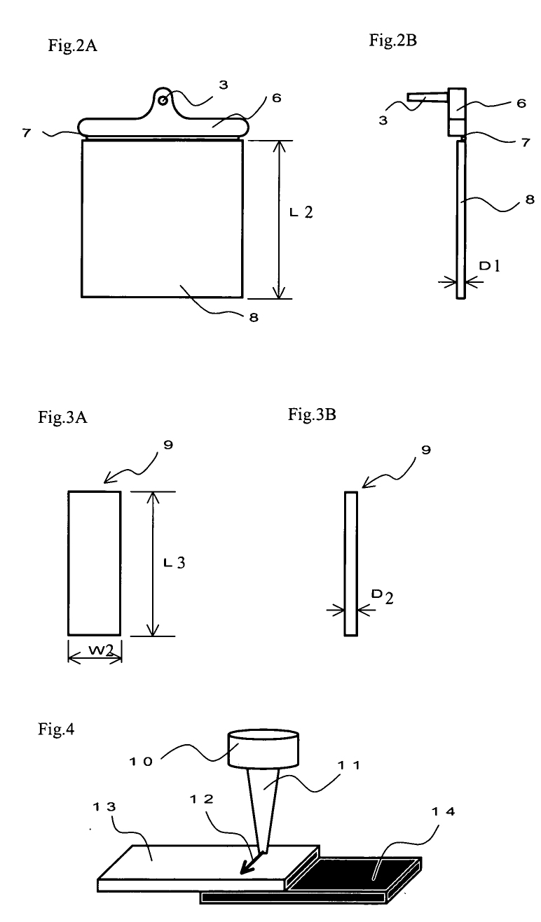

According to the present invention, it is preferred that the laser beam transmittance in the near infrared radiation region of the wavelength of 800 nm to 1100 nm is 10% or greater when it is measured with a sample thickness of 3 mm. The laser beam transmittance in the near infrared radiation region of the wavelength of 800 nm to 1100 nm being 10% or greater upon measurement with a sample thickness of 3 mm can result in achievement of high welding strength in cases of subjecting the colored resin composition for laser welding of the present invention to a laser welding. The laser beam transmittance within this range can be achieved by the specified combination of (A) to (C) as described above. The laser beam transmittance is preferably 12% or greater, because the laser beam transmittance of 12% or greater can result in achievement of high welding strength. In the present invention, an ultraviolet-visible-near-infrared spectrophotometer manufactured by Shimadzu Corporation (UV-3100) is used for evaluation of a laser beam transmittivity, with an integrating sphere as a detector. In connection with the laser beam transmittance, a light transmittance in the near infrared radiation region of the wavelength of 800 nm to 1100 nm is measured with a sample having a thickness of 3 mm, and the ratio of amount of the transmitted light and amount of the incident light is represented by a percentage. Determination of the laser beam transmittance in the near infrared radiation region of the wavelength of 800 nm to 1100 nm is carried out by measuring the laser beam transmittance every 10 nm to find the maximum value and minimum value of the laser beam transmittance in the near infrared radiation region of the wavelength of 800 nm to 1100 nm. FIG. 2A is a plan view illustrating a test piece for evaluating the laser beam transmittivity; and FIG. 2B is a side view illustrating the same test piece. The test piece for evaluating the laser beam transmittivity 8 has a shape of a rectangular parallelepiped with a square bottom. One base L2 of the bottom had a length of 80 mm, and the thickness D1 was 3 mm. By measuring the laser beam transmittance of this test piece, the laser beam transmittance for the sample thickness of 3 mm is determined.

In the present invention, an L value which indicates the luminosity is preferably less than 50. The L value herein means an indicated value of color space represented by L, a and b, and specifically, it is a psychometric lightness indicating the luminosity. The L value of the present invention can be found by measuring the color tone using, for example, a color computer SM-7 manufactured by Suga Test Instruments Co., Ltd. as a color calibrator. On behalf of this L value being less than 50, a dark color tone is provided by the present invention, and also in cases of the laser welding carried out with another dark resin molding articles on the side of laser beam absorption, matching of both color tones is enabled. Therefore, excellent designing properties are achieved. Further, in the present invention, it is more preferable that the L value is less than 30, because the darker color formation is achieved to give excellent design properties, thereby being capable of extending the applicable range such as use in automotive interior furnishing, and the like.

Although the above-mentioned laser beam transmittivity and the L value being less than 50 have been conventionally assumed to be contradictory characteristics, a specified combination of (A) to (C) according to the present invention allows for making both characteristics within the range of the present invention. Accordingly, achieving both excellent design properties and welding strength is enabled.

According to the present invention, an inorganic or organic filler may be further compounded as an ingredient (D). Examples of the ingredient (D) include fibrous reinforcing materials such as glass fibers, carbon fibers, potassium titanate whisker, zinc oxidize whisker, aluminum borate whisker, aramid fibers, alumina fibers, silicon carbide fibers, ceramics fibers, asbestos fibers, gypsum fibers, metal fibers and the like; silicate salts such as wollastonite, zeolite, sericite, kaolin, mica, clay, pyrofilament, bentonite, asbestos, talc, alumina silicate and the like; metal compounds such as alumina, silicon oxide, magnesium oxide, zirconium oxide, titanium oxide, iron oxide and the like; carbonates such as calcium carbide, magnesium carbonate, dolomite and the like; sulfate salts such as calcium sulfate, barium sulfate and the like; nonfibrous reinforcing materials such as glass beads, ceramic beads, boron nitride, silicon carbide, silica and the like. Preferable examples include glass fibers.

It is more preferable that such a filler is used after being subjected to a preliminary treatment with a coupling agent such as that of silane based, epoxy based, titanate based or the like, in consideration of the mechanical strength.

In consideration of the balance between fluidity and mechanical strength, amount of addition of the ingredient (D) for use in the present invention is preferably 1 to 200 parts by weight, more preferably 5 to 120 parts by weight, and particularly preferably 10 to 85 parts by weight per 100 parts by weight of the total amount of the ingredient (A) and the ingredient (B).

According to the present invention, additional shock impact resistance and thermal shock resistance can be imparted while sufficiently keeping the high laser beam transmittivity on behalf of the ingredient (A) and the ingredient (B) through further compounding a styrene based elastomer as an ingredient (E) in addition to the ingredient (A) and the ingredient (B). The thermal shock resistance herein refers to the resistance to a crack of a resin molding product obtained by insert molding therein of, for example, a metal having a greatly different coefficient of linear thermal expansion from that of the polybutylene terephthalate resin, under repeated circumstances at a low temperature and a high temperature. Shock impact resistance and thermal shock resistance can be thereby imparted.

The above-mentioned ingredient (E) for use herein is preferably a styrene based elastomer having a light transmittance in the region of the wavelength of 400 nm to 1100 nm, which is higher than the light transmittance of polybutylene terephthalate in the same region of the wavelength. Examples of the styrene based elastomer include styrene-butadiene block copolymers and the like, and epoxidized products of a styrene-butadiene block copolymer are more preferable.

In consideration of the balance between the laser beam transmittivity, and moldability and thermal shock resistance, amount of addition of the ingredient (E) for use in the present invention is preferably in the range of 1 to 50 parts by weight, and more preferably in the range of 2 to 20 parts by weight per 100 parts by weight of the total amount of the ingredient (A) and the ingredient (B). When the amount of addition is less than 1 part by weight, effect on the shock impact resistance and thermal shock resistance resulting from the addition of the ingredient (E) is scarcely exerted, while use in an amount of greater than 50 parts by weight is not preferred because moldability, particularly fluidity, upon molding of the resin is deteriorated.

To the colored resin composition for laser welding of the present invention may be added a general additive such as a release agent, an antioxidant, a stabilizing agent, a lubricant, a nucleating agent, a end-group cap agent, an ultraviolet ray absorbing agent, a colorant, a fire retardant or the like, and a small amount of another polymer in the range not to impair the effect of the present invention.

Examples of the release agent include e.g., metal soaps such as montanic acid waxes, or lithium stearate, aluminium stearate and the like; higher fatty acid amides such as ethylene bisstearylamide and the like; ethylenediamine-stearic acid-sebacic acid polycondensates and the like. Among them, montanic acid waxes, and ethylene bisstearylamide are preferred.

Examples of the antioxidant include phenolic compounds such as 2,6-di-t-butyl-4-methylphenol, tetrakis(methylene-3-(3,5-di-t-butyl-4-hydroxyphenyl)propionate)methane, tris (3,5-di-t-butyl-4-hydroxybenzine)isocyanurate and the like; sulfuric compounds such as dilauryl-3,3′-thiodipropionate, dimyristyl-3,3′-thiodipropionate and the like; phosphorous compounds such as tris(nonylphenyl) phosphite, distearyl pentaerythritol diphosphite and the like. Among them, 2,6-di-t-butyl-4-methylphenol and tetrakis(methylene-3-(3,5-di-t-butyl-4-hydroxyphenyl)propionate)methane are preferred.

Examples of the stabilizing agent include e.g., benzotriazole based compounds involving 2-(2′-hydroxy-5′-methylphenyl)benzotriazole; and benzophenone based com-pounds such as 2,4-dihydroxybenzophenone; phosphate esters such as mono or distearyl phosphate, trimethyl phosphate and the like.

Moreover, examples of the core agent of a crystal include polyether ether ketone resins, talc and the like. Addition of such a core agent of a crystal enables acceleration of crystallizing velocity (solidifying velocity), thereby permitting the molding cycle to be shortened.

Furthermore, examples of the terminal-blocking agent include aliphatic or aromatic glycidyl esters or glycidyl ethers and the like.

These respective additives may achieve a synergistic effect by combining two or more kinds thereof, therefore, they may be used in combination.

The additive illustrated as, for example, an antioxidant may act as a stabilizing agent or an ultraviolet ray absorbing agent. Also, the compounds illustrated as the stabilizing agent may have an antioxidative action or an ultraviolet ray absorptive action. Accordingly, the foregoing categorization is for the sake of convenience, and does not restrict the action.

Process for producing the colored resin composition for laser welding of the present invention which is preferably used may be as described below, but not limited thereto. Specifically, a process is included in which a biaxial extruder is used, and feeding of the ingredients (A) to (C) as well as the ingredient (E), when the ingredient (E) is to be compounded, from the upper side at a cylinder temperature of 230 to 300° C., followed by kneading. A process in which the ingredient (D) is side fed and additionally subjected to kneading may be included when the ingredient (D) is to be compounded. Further, in the process of the production for use according to the present invention, melting and kneading may be executed using a known melting and mixing machine such as a uniaxial or biaxial extruder, a Banbury mixer, a kneader, a mixing roll or the like at a temperature of 200 to 350° C. Also, each ingredient may be previously admixed as a whole, and then melting and kneading may be perfected. Further, with respect to an additive ingredient to be included in a small amount, for example, 1 parts by weight or less per 100 parts by weight of the total amount of the ingredients (A) to (C), it may be added prior to molding after kneading and pelletizing other ingredients according to the process as described above, and the like. It is preferred that water content adhered to each ingredient is as low as possible, therefore, previous drying beforehand is desired. However, all the ingredients may not necessarily be dried.

The colored resin composition for laser welding of the present invention is generally formed by any of the known molding methods of a thermoplastic resin such as injection molding, extrusion molding, blow molding, transfer molding, vacuum molding or the like. Among them, the resin is suitably used in injection molding.

Although application of the colored resin composition for laser welding of the present invention is not limited as long as it is an application which requires welding of a molding article by a laser welding, the resin is preferably used for automobile parts, electrical or electronic parts, in particular.

The molding product on the side of the laser beam transmission in which the colored resin composition for laser welding of the present invention is used provides high flexibility of the product design, has a dark color tone, and does not stain the mold so much upon injection molding. Moreover, by further adding a filler or an elastomer to the resin composition of the present invention, thermal shock resistance, mechanical strength and the like can be additionally imparted to the molding article.

### EXAMPLE

Examples are demonstrated below to explain the present invention more specifically, however, the present invention is not limited to the description of these Examples. Further, the ratio of addition and compounding presented in the Examples and Comparative Examples are all based on parts by weight.

Hereinafter, methods of the evaluation of material characteristics of the Examples and Comparative Examples are demonstrated.

(1) Evaluation of Moldability

A tensile test piece (type ASTM1, thickness of 3.2 mm) was produced using an injection molding machine (Nissei 60E9ASE) under a molding condition with a cylinder temperature of 260° C. and a mold temperature of 80° C. Those accompanied by deformation of the test piece upon extruding the molding article when molded, or those with great buckling at the extruded portion were determined as unfavorable in molding, which were shown as “x” in the Table. On the other hand, those without deformation were shown as “◯” in the Table.

It was difficult to produce the test piece of those presented by “x,” which were unfavorable in molding, for carrying out the evaluation of other characteristics, therefore, the following evaluations could not be performed. In these respects, the evaluation was shown by “−” in section of each characteristic in the Table.

(2) Evaluation of Molding Cycle Property

In connection with the molding cycle, sealing time at the gate was evaluated which represents the hardening velocity of the resin within the mold. The sealing time at the gate was defined as a primary dwell pressure application time which is obtained when a test piece is subjected to injection molding, starting from the state of a minimum filling pressure until the state in which the weight of the molding article becomes constant through extending the primary dwell pressure application time in a sequential manner. The sealing time at the gate was measured upon injection molding in the above item (1) in accordance with this definition. Materials having a short sealing time at the gate are suitable for high cycle molding because the hardening velocity is great.

(3) Evaluation of Mold Staining Property and Color Tone

Continuous molding was carried out under the same molding condition as that in the above item (1), and the stain level was visually observed when the mold surface and the gas vent were wiped off with an alcohol based solvent following 1000 shots. Accordingly, minor staining was shown as “◯,” and marked staining was shown as “x.”

(4) Color Tone

Color of the molding article surface was measured to give an L value, and those having an L value of less than 30 (black color) were shown as “⊙”; those having a value of 30 or greater and less than 50 (gray color) were shown as “◯”; and those having a value of 50 or greater (bright color) were shown as “x.” A color computer SM-7 manufactured by Suga Test Instruments Co., Ltd. was used as a color calibrator. The number of measurements were five, and determination was performed using the average value therefrom.

(5) Tensile Strength

Evaluation was made with a method according to ASTM D638. The used test piece was of a type ASTM1 (thickness: 3.2 mm), which was formed under a molding condition of: a cylinder temperature being 260° C.; and a mold temperature being 80° C.

(6) Flexural Modulus

Evaluation was made with a method according to ASTM D790. The used test piece had a thickness of 3.2 mm, which was formed under a molding condition of: a cylinder temperature being 260° C., and a mold temperature being 80° C.

(7) Impact Strength

Evaluation was made with a method according to ASTM D256. The used test piece had a width of 3.2 mm and was provided with a notch, which was formed under a molding condition of: a cylinder temperature being 260° C., and a mold temperature being 80° C.

(8) Deflection Temperature Under Load

Evaluation was made with a method according to ASTM D648 with a load stress of 1.82 MPa. The used test piece had a thickness of 6.4 mm, which was formed under a molding condition of: a cylinder temperature being 260° C., and a mold temperature being 80° C.

(9) Evaluation of Thermal Shock Resistance

A molding article obtained according to the following process was subjected to a thermal shock cycle treatment in which a treatment under an atmosphere of 130° C. for one hour and a treatment under an atmosphere of −40° C. for one hour are carried out followed by being left to stand again under an atmosphere of 130° C. Then, the appearance of the molding article was visually observed. The number of cycles repeated until a crack was generated on the insert molding article is described in the Table. The extent of the resulting value was used as a marker of the thermal shock resistance.

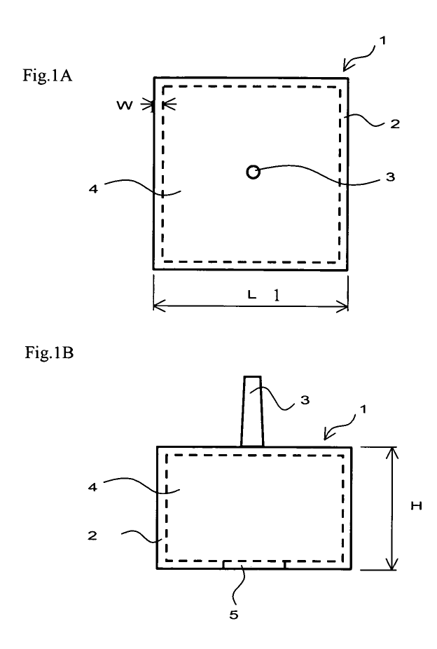

The insert molding article is produced according to the following process. FIG. 1A depicts a plan view illustrating the above-mentioned insert molding article; and FIG. 1B depicts a side view illustrating the same molding article. The insert molding article 1 is formed with an injection molding process in which an insert metal 4 (explicitly shown in FIGS. 1A and 1B by a wavy line) is placed and fixed in a mold cavity; a melted resin is injected such that the insert metal 4 is covered; and then resin 2 and sprue 3 are solidified. The production is conducted under a condition of a cylinder temperature being 260° C., and a mold temperature being 80° C.

The quadratic prism portion of the insert molding article 1 has a bottom face (square) with a side having a length L1 of 50 mm, and has a height of 30 mm. The resin 2 has a thickness W1 of 1.5 mm.

(10) Evaluation of Laser Beam Transmittivity

For the evaluation of a laser beam transmittivity, an ultraviolet-visible-near-infrared spectrophotometer manufactured by Shimadzu Corporation (UV-3100) was used, and an integrating sphere was used as a detector. In connection with the laser beam transmittance, a light transmittance in the near infrared radiation region of the wavelength of 800 nm to 1100 nm was measured with a sample having a thickness of 3 mm, and the ratio of amount of the transmitted light and amount of the incident light was represented by a percentage in the Table. Determination of the laser beam transmittance in the near infrared radiation region of the wavelength of 800 nm to 1100 nm was carried out by measuring the laser beam transmittance every 10 nm to find the maximum value and minimum value of the laser beam transmittance in the near infrared radiation region of the wavelength of 800 nm to 1100 nm. The determination is carried out five times, and each average value of the upper limit value and lower limit value was found. FIG. 2A is a plan view illustrating a test piece for evaluating the laser beam transmittivity; and FIG. 2B is a side view illustrating the same test piece. The test piece for evaluating the laser beam transmittivity 8 had a shape of a rectangular parallelepiped with a square bottom. One base of the bottom had a length L2 of 80 mm, and the thickness D1 was 3 mm. Moreover, the test piece was produced by injection molding under a molding condition of a cylinder temperature being 260° C. and a mold temperature being 80° C., and cutting out from the sprue 3, runner 6 and gate 7 after completing the injection molding.

(11) Evaluation of Laser Welding Property

For the evaluation of the laser welding property, MODULAS C available from LEISTER (wavelength of the laser beam being a near infrared radiation of 940 nm, with the maximum output of 35 W, a focal distance L of 38 mm and a focal point diameter D of 0.6 mm) was used to evaluate the possibility of welding upon use of a test piece having a thickness of 3 mm and upon use of a test piece having a thickness of 2 mm, for the sample on the side of the laser beam transmission. The case in which a molten trace is found on the light entrance surface of the laser beam transmission sample is shown as “x,” and the case in which no molten trace is found and possible welding is suggested is shown as “◯.” FIG. 3A is a plan view illustrating an outline of a test piece for laser welding (sample on the side of laser beam absorption) 9; and FIG. 3B is a side view of the same. The test piece for laser welding 9 had a width W2 of 24 mm, a length L3 of 70 mm, and either one of two thicknesses D2 of 3 mm and 2 mm. Furthermore, the test piece for laser welding 9 was produced in a similar manner to the test piece for evaluating the laser beam transmittivity under a molding condition of a cylinder temperature being 260° C. and a mold temperature being 80° C., followed by cutting out from the sprue 3, runner 6 and gate 7 after completing the injection.

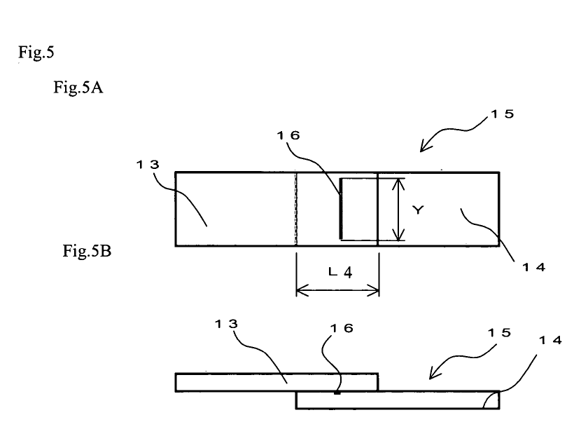

FIG. 4 is a schematic view illustrating an outline of a laser welding process. The laser welding process is, as shown in FIG. 4, performed by placing the sample on the side of the laser beam transmission 13 on top and the test piece for laser welding 14 on the bottom to lay over, and irradiating a laser beam from above. The laser irradiation is conducted along the laser welding track 12 under a laser welding condition of an output being in the range of 15 W to 35 W and a laser scanning rate being in the range of 1 to 50 mm/sec to achieve the most favorable welding strength. The process was performed with a focal distance L of 38 mm and a focal point diameter D of 0.6 mm which was fixed.

(12) Welding Strength

For the measurement of the welding strength, a tensile test was carried out using a tensile testing machine (AG-500B), while fixing both ends of a test piece to allow generation of the tension shear stress at the welded side. Upon measurement of the strength, a strain rate of 1 mm/min, and the span of 40 mm were employed with the number of measurements five times. Thus, the resulting average value was determined as the welding strength. The welding strength was defined as a stress generated upon breakage at the welded site. FIG. 5A depicts a schematic plan view illustrating a test piece for measuring strength of the laser welding executed according to the process as described above; and FIG. 5B depicts a side view of the same. The test piece for the measurement of laser welding strength 15 was prepared by overlaying the sample on the side of the laser beam transmission 13 and the sample on the side of the laser beam absorption 14 such that the overlaying length L4 becomes 30 mm and the welding distance Y becomes 20 mm, and then welding at a laser welding part 16 is performed. The colored resin composition for laser welding of the present invention was used for the laser beam transmission sample, and a material prepared by adding 43 parts by weight of a glass fiber to 100 parts by weight of a polybutylene terephthalate resin followed by further adding thereto 0.4 part of carbon black was used for the sample on the side of the laser beam absorption. The sample on the side of the laser beam absorption was produced by a process of production which is similar to that in the example.

### Reference Example 1 (a-2) Process For Producing PBT/I

Terephthalic acid (hereinafter, also referred to as TPA) in an amount of 450 parts and isophthalic acid (hereinafter, also referred to as IPA) in an amount of 50 parts [TPA/IPA=90/10 mol %], 407 parts of 1,4-butanediol, 1 part of tetra-n-butyl titanate were charged into a reaction vessel equipped with a rectification column, and a reaction was allowed to proceed until a ratio of the esterification reaction of 95% or greater was achieved by gradually elevating the temperature 180° C. to 230° C. under an atmosphere of a reduced pressure of 500 mmHg. Then, the temperature was elevated to 240° C., and the pressure was reduced to 0.5 mmHg to complete the polymerization after three and half hours. Thus resulting copolymer had an intrinsic viscosity of 0.80 dl/g.

### Examples 1 Through 10, Comparative Examples 1 Through 12

Polybutylene terephthalate having an intrinsic viscosity of 0.81 dl/g (a-1) (“TORAYCON 100S,” manufactured by Toray Industries, Inc.) and the polybutylene terephthalate/isophthalate copolymer (PBT/I) (a-2) produced in Reference Example 1 were used to produce the ingredient (A) (polybutylene terephthalate based resin) with (a-1) alone or through blending (a-1) and (a-2). In addition, any one of the following (B-1) to (B-3) as the ingredient (B), either a mixture including the ingredients described in (C-1) to (C-9) (proportion represented by weight ratio) or a single ingredient therefrom as the ingredient (C) (organic pigment), and the following (D-1) when the ingredient (D) (glass fiber) is to be added and compounded were employed. Using a biaxial extruder with a predetermined cylinder temperature of 250° C. having a screw diameter of 57 mm, melting and kneading was carried out through feeding the ingredient (A) (polybutylene terephthalate based resin), the ingredient (B), the ingredient (C) (organic pigment) and another additive from a breech-loading part, and feeding the ingredient (D) (glass fiber) from a side feeder when it is to be added and compounded. After cooling the strand which was discharged from the die in a cooling bath, a resin composition for laser welding was obtained by pelletizing with a strand cutter. After drying the thus resulting pellet with a hot air drier at 130° C. for 3 hours, molding and then evaluation were performed. The results of evaluation are shown in Table 2. Any one of the unreinforced polybutylene terephthalate based resin compositions and glass fiber-reinforced polybutylene terephthalate based resin compositions which was obtained in this Example exhibited superior moldability, had a dark color tone, and gave less staining of the mold. Also, any one of them exhibited the transmittivity at a high level which permits applications on the side of the laser beam transmission upon laser welding in a thickness of 3 mm. When the sample having a thickness of 3 mm was used on the side of the laser beam transmission, no molten trace was generated on the light entrance surface of the laser beam transmission sample, and potent welding strength was demonstrated. Therefore, a great flexibility in product design was provided upon designing of the product. On the other hand, the resin composition obtained in Comparative Examples 1 through 12 exhibited inferior moldability, or otherwise, yielded low laser beam transmittance even though molding is enabled, in which case a molten trace was generated on the laser entrance surface of the molding product upon use of the sample on the side of the laser beam transmission having a thickness of 3 mm, thereby resulting in the requirement of thin-walling of the product to lead to inferior flexibility of the product design. In addition, use of a dye enabled the laser welding, and provided a dark color tone, however, marked staining of the mold was found at an unpractical level.
(B-1) PC: Polycarbonate resin, Panlite L-1225L, manufactured by Teijin Chemicals Ltd. (viscosity average molecular weight: about 19000).
(B-2) AS: Acrylonitrile-styrene copolymer (ratio of copolymerization of acrylonitrile and styrene: acrylonitrile/styrene=24/76 (weight ratio), intrinsic viscosity: 0.60 dl/g).
(B-3) PET: Polyethylene terephthalate resin, intrinsic viscosity: 0.72 dl/g.
(C-1): Monoazo lake red pigment (PR151)/phthalocyanine blue pigment (PB15:3)=2:1
(C-2): Monoazo lake red pigment (PR151)/monoazo lake yellow pigment (PY183)/phthalo-cyanine blue pigment (PB15:3)=2:2:1
(C-3): Monoazo lake red pigment (PR151)/disazo yellow pigment (PY128)/phthalocyanine blue pigment (PB15:3)=3:1:4
(C-4): Monoazo lake red pigment (PR151)/anthraquinone yellow pigment (PY138)/phthalo-cyanine blue pigment (PB15:3)=2:2:1
(C-5): Perylene red pigment (PR178)/phthalocyanine blue pigment (PB5:3)=2:1
(C-6): Quinacridone yellow pigment (PY122)/phthalocyanine blue pigment (PB5:3)=2:1
(C-7): Monoazo lake red pigment (PR151)/disazo yellow pigment (PY128)=1:1
(C-8): Monoazo lake red pigment (PR151) alone
(C-9): Anthraquinone based red dye/anthraquinone based blue dye/perynone based orange dye=2:1:2

(D-1) GF: Glass fiber T-187, manufactured by Nippon Electric Glass Co., Ltd., (chopped strand having a mean fiber diameter of 13 μm and a fiber length of 3 mm).

TABLE 1

| | | | Example | | | | | | | | | |
|---|---|---|---|---|---|---|---|---|---|---|---|---|
| | Item | Unit | 1 | 2 | 3 | 4 | 5 | 6 | 7 | 8 | 9 | 10 |
| Compound | PBT | Wt % | 70 | 70 | 70 | 70 | 70 | 50 | 79 | 57 | 57 | 50 |
| composition | PBT/I | Wt % | — | — | — | — | — | 20 | — | — | — | 29 |
| | PC | Wt % | 30 | 30 | 30 | — | — | 30 | 21 | 43 | 43 | 21 |
| | AS | Wt % | — | — | — | 30 | — | — | — | — | — | — |
| | PET | Wt % | — | — | — | — | 30 | — | — | — | — | — |
| | Talc (nuclear agent) | Wt % | — | — | — | — | — | — | — | — | 0.05 | — |
| | GF | Wt % | — | — | — | — | — | — | 43 | 43 | 43 | 43 |
| | Organic pigment (C-1) | Wt % | 0.03 | 0.08 | — | 0.05 | 0.05 | 0.05 | 0.05 | 0.05 | 0.05 | 0.05 |
| | Organic pigment (C-2) | Wt % | — | — | 0.05 | — | — | — | — | — | — | — |
| | Organic pigment (C-8) | Wt % | — | — | — | — | — | — | — | — | — | — |
| | Dye (C-9) | Wt % | — | — | — | — | — | — | — | — | — | — |
| Characteristic | Transmittivity (3 mmt) | % | 16-19 | 14-17 | 14-17 | 10-12 | 10-12 | 18-21 | 15-17 | 18-22 | 14-16 | 17-19 |
| | Moldability | — | ◯ | ◯ | ◯ | ◯ | ◯ | ◯ | ◯ | ◯ | ◯ | ◯ |
| | Sealing time at gate | sec | 8.5 | 8.5 | 8.5 | 8.0 | 9.0 | 9.0 | 7.0 | 7.5 | 6.0 | 7.5 |
| | Staining of mold | — | ◯ | ◯ | ◯ | ◯ | ◯ | ◯ | ◯ | ◯ | ◯ | ◯ |
| | Color tone (L value) | — | ◯ | ◯ | ◯ | ◯ | ◯ | ◯ | ◯ | ◯ | ◯ | ◯ |
| | Tensile strength | MPa | 55 | 56 | 55 | 55 | 52 | 50 | 140 | 147 | 149 | 150 |
| | Flexural modulus | GPa | 2.5 | 2.6 | 2.6 | 2.5 | 2.4 | 2.3 | 9 | 9.1 | 9.2 | 9.2 |
| | Impact strength | J/m | 50 | 48 | 49 | 50 | 45 | 50 | 117 | 150 | 148 | 149 |
| | Deflection temperature | ° C. | 60 | 59 | 60 | 60 | 60 | 58 | 205 | 159 | 161 | 196 |
| | under load | | | | | | | | | | | |
| | Possibility of welding | — | ◯ | ◯ | ◯ | ◯ | ◯ | ◯ | ◯ | ◯ | ◯ | ◯ |
| | (3 mmt) | | | | | | | | | | | |
| | Welding strength | MPa | 40 | 38 | 38 | 37 | 36 | 38 | 39 | 38 | 37 | 38 |
| | (3 mmt) | | | | | | | | | | | |
| | Welding condition | (W/mm/s) | (35/7) | (35/7) | (35/7) | (35/6) | (35/6) | (35/8) | (35/6) | (35/8) | (35/6) | (35/7) |
| | (output/velocity) | | | | | | | | | | | |

| | | | Comparative Example | | | | | | | | | | | |
|---|---|---|---|---|---|---|---|---|---|---|---|---|---|---|
| | Item | Unit | 1 | 2 | 3 | 4 | 5 | 6 | 7 | 8 | 9 | 10 | 11 | 12 |
| Compound | PBT | Wt % | 70 | 70 | 70 | 70 | — | 30 | — | 100 | 21 | — | — | — |
| composition | PBT/I | Wt % | — | — | — | — | 100 | — | 70 | — | — | 57 | 79 | 100 |
| | PC | Wt % | 30 | 30 | 30 | 30 | — | 70 | 30 | — | 79 | 43 | 21 | — |
| | AS | Wt % | — | — | — | — | — | — | — | — | — | — | — | — |
| | PET | Wt % | — | — | — | — | — | — | — | — | — | — | — | — |
| | Talc (nuclear agent) | Wt % | — | — | — | — | — | — | — | — | — | — | — | — |
| | GF | Wt % | — | — | — | — | — | — | — | 43 | 43 | 43 | 43 | 43 |
| | Organic pigment | Wt % | 0.01 | 0.70 | — | — | 0.05 | 0.05 | 0.05 | 0.05 | 0.05 | 0.05 | 0.05 | 0.05 |
| | (C-1) | | | | | | | | | | | | | |
| | Organic pigment | Wt % | — | — | — | — | — | — | — | — | — | — | — | — |
| | (C-2) | | | | | | | | | | | | | |
| | Organic pigment | Wt % | — | — | 0.05 | — | — | — | — | — | — | — | — | — |
| | (C-8) | | | | | | | | | | | | | |
| | Dye (C-9) | Wt % | — | — | — | 0.10 | — | — | — | — | — | — | — | — |
| Characteristic | Transmittivity | % | 16-19 | 6-8 | 14-17 | 17-20 | — | — | — | 6-7 | — | — | — | 7-9 |
| | (3 mmt) | | | | | | | | | | | | | |
| | Moldability | — | ◯ | ◯ | ◯ | ◯ | x | x | x | ◯ | x | x | x | ◯ |
| | Sealing time at gate | sec | 8.5 | 8.5 | 8.5 | 8.5 | — | — | — | 6.5 | — | — | — | 9.0 |
| | Staining of mold | — | ◯ | ◯ | ◯ | x | — | — | — | ◯ | — | — | — | ◯ |
| | Color tone (L value) | — | x | ⊚ | x | ⊚ | — | — | — | ◯ | — | — | — | ◯ |
| | Tensile strength | MPa | 55 | 51 | 55 | 55 | — | — | — | 140 | — | — | — | 136 |
| | Flexural modulus | GPa | 2.5 | 2.7 | 2.6 | 2.5 | — | — | — | 9.2 | — | — | — | 8.6 |
| | Impact strength | J/m | 50 | 35 | 48 | 50 | — | — | — | 76 | — | — | — | 88 |
| | Deflection | ° C. | 60 | 58 | 60 | 59 | — | — | — | 210 | — | — | — | 201 |
| | temperature | | | | | | | | | | | | | |
| | under load | | | | | | | | | | | | | |
| | Possibility of | — | ◯ | x | ◯ | ◯ | — | — | — | x | — | — | — | x |
| | welding (3 mmt) | | | | | | | | | | | | | |
| | Welding strength | MPa | 40 | — | 38 | 40 | — | — | — | — | — | — | — | — |
| | (3 mmt) | | | | | | | | | | | | | |
| | Welding condition | (W/mm/s) | (35/7) | — | (35/7) | (35/7) | — | — | — | — | — | — | — | — |
| | (output/velocity) | | | | | | | | | | | | | |

### Examples 11 Through 22, Comparative Examples 13 Through 21

Using a biaxial extruder with a predetermined cylinder temperature of 250° C. having a screw diameter of 57 mm, melting and kneading was carried out through feeding the ingredient (A) (polybutylene terephthalate based resin), the above-mentioned polycarbonate resin (B-1), either a mixture including ingredients described in (C-1) to (C-9) (proportion represented by weight ratio) or a single ingredient therefrom, as well as the following material as the ingredient (E) and another additive from a breech-loading part, and feeding the ingredient (D) (glass fiber) from a side feeder when it is to be added and compounded. After cooling the strand which was discharged from the die in a cooling bath, a resin composition for laser welding was obtained by pelletizing with a strand cutter. After drying the thus resulting each material with a hot air drier at 130° C. for 3 hours, molding and then evaluation were performed. The results of evaluation are shown in Table 2.

Also in cases in which any of the various types of elastomers were added and compounded to the composition obtained in Examples 1 through 10 for the purpose of imparting thermal shock resistance and shock impact resistance, improvement of the thermal shock resistance and shock impact resistance, and retention of the laser beam transmittivity level to allow for the laser welding were both achieved. Any one of the resin compositions obtained in the present invention exhibited excellent welding strength without generating a molten trace on the light entrance surface of the laser beam transmission sample when the sample having a thickness of 2 mm is used on the side of the laser beam transmission, and had a dark color tone. The used elastomer described below had a light transmittance of 60% or greater at 400 nm to 1100 nm with a thickness of 1 mm, although a PBT resin had the value of 40% or less.

On the other hand, the resin compositions obtained in Comparative Examples 13 through 21 had a dark color tone, however, they exhibited inferior moldability, or otherwise, yielded low laser beam transmittance even though molding is enabled, in which case the defect of generation of a molten trace on the light entrance surface of the molding product was caused upon use of the sample on the side of the laser beam transmission having a thickness of 3 mm. (E-1) Elastomer (styrene base): styrene-butadiene block copolymer epoxidized product, Epofriend A1010 manufactured by Daicel Chemical Industries, Ltd. (ratio of copolymerization of styrene and butadiene: styrene/butadiene=40/60 (weight ratio), epoxy equivalent weight 1000, MFR=7 g/10 min (method of measurement: JIS-K7210)).

(E-2) Elastomer (Ethylene Base A)

Ethylene-glycidyl methacrylate copolymer. Copolymerization ratio (weight ratio) of both ingredients is ethylene unit/glycidyl methacrylate unit=94/6 (% by weight). MFR=3.2 g/10 min (method of measurement: JIS-K6760 (190° C., 2160 g load)).

(E-3) Elastomer (Ethylene Base B)

Ethylene-α-olefin copolymer (copolymerization ratio of ethylene and 1-butene: ethylene/1-butene=84/16 (weight ratio), MFR=3.6 g/10 min (method of measurement: JIS-K6760 (190° C., 2160 g load))).

(E-4) Elastomer (Ethylene Base C)

Ethylene-methyl acrylate-glycidyl methacrylate copolymer. Copolymerization ratio (weight ratio) of each ingredient is ethylene unit/methyl acrylate unit/glycidyl methacrylate unit=64/30/6 (% by weight). MFR=9 g/10 min (method of measurement: JIS-K6760 (190° C., 2160 g load)).

(E-5) Elastomer (Ethylene Base D)

Ethylene-ethyl acrylate copolymerized product. Copolymerization ratio (weight ratio) of both ingredients is ethylene unit/ethyl acrylate unit=65/35 (% by weight). MFR=25 g/10 min (method of measurement: JIS-K6760 (190° C., 2160 g load)).

TABLE 2

| | | | Example | | | | | | | | | | |
|---|---|---|---|---|---|---|---|---|---|---|---|---|---|
| | Item | Unit | 11 | 12 | 13 | 14 | 15 | 16 | 17 | 18 | 19 | 20 | 21 |
| Com- | PBT//PC (79:21) | Wt % | 100 | 100 | 100 | 100 | 100 | 100 | 100 | 100 | 100 | 100 | 100 |
| pound | PBT | Wt % | — | — | — | — | — | — | — | — | — | — | — |
| compo- | PBT/I | Wt % | — | — | — | — | — | — | — | — | — | — | — |
| sition | Elastomer | Wt % | — | 6 | 6 | 6 | 6 | 6 | 6 | 11 | — | — | — |
| | (styrene base) | | | | | | | | | | | | |
| | Elastomer (ethylene | Wt % | — | — | — | — | — | — | — | — | 6 | — | — |
| | base A) | | | | | | | | | | | | |
| | Elastomer (ethylene | Wt % | — | — | — | — | — | — | — | — | — | 6 | — |
| | base B) | | | | | | | | | | | | |
| | Elastomer (ethylene | Wt % | — | — | — | — | — | — | — | — | — | — | 6 |
| | base C) | | | | | | | | | | | | |
| | Elastomer (ethylene | Wt % | — | — | — | — | — | — | — | — | — | — | — |
| | base D) | | | | | | | | | | | | |
| | GF | Wt % | 43 | 45 | 45 | 45 | 45 | 45 | 45 | 48 | 35 | 35 | 35 |
| | Organic pigment (C-1) | Wt % | 0.05 | 0.05 | — | — | — | — | — | 0.05 | 0.05 | 0.05 | 0.05 |
| | Organic pigment (C-3) | Wt % | — | — | 0.15 | — | — | — | — | — | — | — | — |
| | Organic pigment (C-4) | Wt % | — | — | — | 0.50 | — | — | — | — | — | — | — |
| | Organic pigment (C-5) | Wt % | — | — | — | — | 0.10 | — | — | — | — | — | — |
| | Organic pigment (C-6) | Wt % | — | — | — | — | — | 0.10 | | — | — | — | — |
| | Organic pigment (C-7) | Wt % | — | — | — | — | — | | 0.10 | — | — | — | — |
| Charac- | Trasmittivity (3 mmt) | % | 15-17 | 13-15 | 11-13 | 10-12 | 12-14 | 12-14 | 12-14 | 13-14 | 11-12 | 11-12 | 10-11 |
| teris- | Moldability | — | ◯ | ◯ | ◯ | ◯ | ◯ | ◯ | ◯ | ◯ | ◯ | ◯ | ◯ |
| tic | Sealing time at gate | sec | 7.0 | 7.0 | 7.0 | 7.0 | 7.0 | 7.0 | 7.0 | 7.0 | 7.0 | 7.0 | 7.0 |
| | Staining of mold | — | ◯ | ◯ | ◯ | ◯ | ◯ | ◯ | ◯ | ◯ | ◯ | ◯ | ◯ |
| | Color tone (L value) | — | ◯ | ◯ | ⊚ | ⊚ | ◯ | ◯ | ◯ | ◯ | ◯ | ◯ | ◯ |
| | Tensile strength | MPa | 140 | 131 | 132 | 132 | 131 | 131 | 131 | 124 | 125 | 124 | 128 |
| | Flexural modulus | GPa | 9 | 8.7 | 8.7 | 8.8 | 8.7 | 8.7 | 8.7 | 8.3 | 8.4 | 8.4 | 8.3 |
| | Impact strength | J/m | 115 | 131 | 130 | 128 | 131 | 131 | 131 | 164 | 125 | 122 | 133 |
| | Deflection temperature | ° C. | 205 | 204 | 204 | 204 | 204 | 204 | 204 | 201 | 202 | 201 | 202 |
| | under load | | | | | | | | | | | | |
| | Thermal shock | cycle | 40 | 150 or | 150 or | 150 or | 150 or | 150 or | 150 or | 150 or | 150 or | 150 or | 150 or |
| | resistance | | | more | more | more | more | more | more | more | more | more | more |
| | Possibility of welding | — | ◯ | ◯ | ◯ | x | ◯ | ◯ | ◯ | ◯ | x | x | x |
| | (3 mmt) | | | | | | | | | | | | |
| | Possibility of welding | — | ◯ | ◯ | ◯ | ◯ | ◯ | ◯ | ◯ | ◯ | ◯ | ◯ | ◯ |
| | (2 mmt) | | | | | | | | | | | | |
| | Welding strength | MPa | 38 | 37 | 35 | 34 | 36 | 37 | 37 | 36 | 36 | 37 | 38 |
| | (2 mmt) | | | | | | | | | | | | |
| | Welding condition | (W/mm/s) | (35/25) | (35/20) | (35/20) | (35/12) | (35/20) | (35/20) | (35/20) | (35/20) | (35/12) | (35/12) | (35/10) |
| | (output/velocity) | | | | | | | | | | | | |

| | | | Exam- | | | | | | | | | |
|---|---|---|---|---|---|---|---|---|---|---|---|---|
| | | | ple | Comparative Example | | | | | | | | |
| | Item | Unit | 22 | 13 | 14 | 15 | 16 | 17 | 18 | 19 | 20 | 21 |
| Compound | PBT//PC (79:21) | Wt % | 100 | — | — | — | — | — | — | — | — | — |
| composition | PBT | Wt % | — | 100 | 100 | 100 | 100 | 100 | — | — | — | — |
| | PBT/I | Wt % | — | — | — | — | — | — | 100 | 100 | 100 | 100 |
| | Elastomer (styrene base) | Wt % | — | 6 | — | — | — | — | — | — | — | — |
| | Elastomer (ethylene | Wt % | — | — | 6 | — | — | — | 6 | — | — | — |
| | base A) | | | | | | | | | | | |
| | Elastomer (ethylene | Wt % | — | — | — | 6 | — | — | — | 6 | — | — |
| | base B) | | | | | | | | | | | |
| | Elastomer (ethylene | Wt % | — | — | — | — | 6 | — | — | — | 6 | — |
| | base C) | | | | | | | | | | | |
| | Elastomer (ethylene | Wt % | 6 | — | — | — | — | 6 | — | — | — | 6 |
| | base D) | | | | | | | | | | | |
| | GF | Wt % | 35 | 45 | 45 | 45 | 45 | 45 | 45 | 45 | 45 | 45 |
| | Organic pigment (C-1) | Wt % | 0.05 | 0.05 | 0.05 | 0.05 | 0.05 | 0.05 | 0.05 | 0.05 | 0.05 | 0.05 |
| | Organic pigment (C-3) | Wt % | — | — | — | — | — | — | — | — | — | — |
| | Organic pigment (C-4) | Wt % | — | — | — | — | — | — | — | — | — | — |
| | Organic pigment (C-5) | Wt % | — | — | — | — | — | — | — | — | — | — |
| | Organic pigment (C-6) | Wt % | — | — | — | — | — | — | — | — | — | — |
| | Organic pigment (C-7) | Wt % | — | — | — | — | — | — | — | — | — | — |
| Characteristic | Trasmittivity (3 mmt) | % | 10-11 | 4-5 | 3-4 | 3-4 | 2-3 | 2-3 | 3-4 | 3-4 | 2-3 | 2-3 |
| | Moldability | — | ◯ | ◯ | ◯ | ◯ | ◯ | ◯ | ◯ | ◯ | ◯ | ◯ |
| | Sealing time at gate | sec | 7.0 | 6.0 | 6.0 | 6.0 | 6.0 | 6.0 | 7.0 | 7.0 | 7.0 | 7.0 |
| | Staining of mold | — | ◯ | ◯ | ◯ | ◯ | ◯ | ◯ | ◯ | ◯ | ◯ | ◯ |
| | Color tone (L value) | — | ◯ | ◯ | ◯ | ◯ | ◯ | ◯ | ◯ | ◯ | ◯ | ◯ |
| | Tensile strength | MPa | 127 | 130 | 130 | 129 | 133 | 132 | 130 | 129 | 133 | 132 |
| | Flexural modulus | GPa | 8.3 | 8.6 | 8.7 | 8.7 | 8.6 | 8.6 | 8.7 | 8.7 | 8.6 | 8.6 |
| | Impact strength | J/m | 134 | 129 | 130 | 128 | 139 | 141 | 127 | 128 | 139 | 141 |
| | Deflection temperature | ° C. | 201 | 209 | 209 | 208 | 210 | 209 | 207 | 207 | 206 | 207 |
| | under load | | | | | | | | | | | |
| | Thermal shock resistance | cycle | 150 or | 120 | 120 | 120 | 150 or | 150 or | 120 | 120 | 150 or | 150 or |
| | | | more | | | | more | more | | | more | more |
| | Possibility of welding | — | x | x | x | x | x | x | x | x | x | x |
| | (3 mmt) | | | | | | | | | | | |
| | Possibility of welding | — | ◯ | x | x | x | x | x | x | x | x | x |
| | (2 mmt) | | | | | | | | | | | |
| | Welding strength | MPa | 37 | — | — | — | — | — | — | — | — | — |
| | (2 mmt) | | | | | | | | | | | |
| | Welding condition | (W/mm/s) | (35/10) | — | — | — | — | — | — | — | — | — |
| | (output/velocity) | | | | | | | | | | | |

1. A colored resin composition for laser welding which comprises:
(A) a polybutylene terephthalate based resin comprising polybutylene terephthalate or polybutylene terephthalate and a polybutylene terephthalate copolymer,
(B) at least one kind of resin selected from polycarbonate resins, styrene based resins and polyethylene terephthalate resins, and
(C) two or more kinds of organic pigments, wherein
the resin (B) accounts for 1 to 50% by weight of the total amount of the polybutylene terephthalate based resin (A) and the resin (B), and
the pigment (C) is included in an amount of 0.02 to 0.5 parts by weight per 100 parts by weight of the total amount of the polybutylene terephthalate based resin (A) and the resin (B).

2. A colored resin composition for laser welding which comprises:
(A) a polybutylene terephthalate based resin comprising polybutylene terephthalate or polybutylene terephthalate and a polybutylene terephthalate copolymer,
(B) at least one kind of resin selected from polycarbonate resins, styrene based resins and polyethylene terephthalate resins, and
(C) two or more kinds of organic pigments, wherein
the resin (B) accounts for 1 to 50% by weight of the total amount of the polybutylene terephthalate based resin (A) and the resin (B),
the pigment (C) is included in an amount of 0.02 to 0.5 parts by weight per 100 parts by weight of the total amount of the polybutylene terephthalate based resin (A) and the resin (B),
laser beam transmittance in the near infrared radiation region of the wavelength of 800 nm to 1100 nm is 10% or greater when it is measured with a sample thickness of 3 mm, and
L value which indicates the luminosity is less than 50.

3. The colored resin composition for laser welding according to claim 1 wherein two or more kinds of organic pigments (C) are added and compounded in an amount of 0.02 to 0.1 parts by weight per 100 parts by weight of the total amount of the polybutylene terephthalate based resin (A) and the resin (B).

4. The colored resin composition for laser welding according to claim 2 wherein two or more kinds of organic pigments (C) are added and compounded in an amount of 0.02 to 0.1 parts by weight per 100 parts by weight of the total amount of the polybutylene terephthalate based resin (A) and the resin (B).

5. The colored resin composition for laser welding according to claim 1 wherein (D) at least one kind of filler selected from inorganic fillers and organic fillers is added and compounded in an amount of 1 to 200 parts by weight per 100 parts by weight of the total amount of the polybutylene terephthalate based resin (A) and the resin (B).

6. The colored resin composition for laser welding according to claim 2 wherein (D) at least one kind of filler selected from inorganic fillers and organic fillers is added and compounded in an amount of 1 to 200 parts by weight per 100 parts by weight of the total amount of the polybutylene terephthalate based resin (A) and the resin (B).

7. The colored resin composition for laser welding according to claim 3 wherein (D) at least one kind of filler selected from inorganic fillers and organic fillers is added and compounded in an amount of 1 to 200 parts by weight per 100 parts by weight of the total amount of the polybutylene terephthalate based resin (A) and the resin (B).

8. The colored resin composition for laser welding according to claim 1 wherein (E) a styrene based elastomer is added and compounded in an amount of 1 to 50 parts by weight per 100 parts by weight of the total amount of the polybutylene terephthalate based resin (A) and the resin (B).

9. The colored resin composition for laser welding according to claim 2 wherein (E) a styrene based elastomer is added and compounded in an amount of 1 to 50 parts by weight per 100 parts by weight of the total amount of the polybutylene terephthalate based resin (A) and the resin (B).

10. The colored resin composition for laser welding according to claim 3 wherein (E) a styrene based elastomer is added and compounded in an amount of 1 to 50 parts by weight per 100 parts by weight of the total amount of the polybutylene terephthalate based resin (A) and the resin (B).

11. The colored resin composition for laser welding according to claim 8 wherein the styrene based elastomer (E) has a light transmittance in the region of the wavelength of 400 nm to 1100 nm, which is higher than the light transmittance of polybutylene terephthalate in the same region of the wavelength.

12. The colored resin composition for laser welding according to claim 9 wherein the styrene based elastomer (E) has a light transmittance in the region of the wavelength of 400 nm to 1100 nm, which is higher than the light transmittance of polybutylene terephthalate in the same region of the wavelength.

13. The colored resin composition for laser welding according to claim 10 wherein the styrene based elastomer (E) has a light transmittance in the region of the wavelength of 400 nm to 1100 nm, which is higher than the light transmittance of polybutylene terephthalate in the same region of the wavelength.

14. A composite molding product obtained by laser welding of a molding article which comprises the colored resin composition for laser welding according to claim 1.

15. A composite molding product obtained by laser welding of a molding article which comprises the colored resin composition for laser welding according to claim 2.

16. A composite molding product obtained by laser welding of a molding article which comprises the colored resin composition for laser welding according to claim 3.
